(19) United States
(12) Patent Application Publication
(10) Pub. No.: US 2004/0258277 A1
(43) Pub. Date: Dec. 23, 2004

(54) Information processing apparatus and computer program product

(76) Inventor: Naofumi Ueda, Souraku-gun (JP)

Correspondence Address: BIRCH STEWART KOLASCH & BIRCH, PO BOX 747, FALLS CHURCH, VA, 22040-0747, US

(21) Appl. No.: 10/867,632

(22) Filed: Jun. 16, 2004

(30) Foreign Application Priority Data
Jun. 17, 2003 (JP) 2003-172511

(51) Int. Cl. G06K 9/00

(52) U.S. Cl. 382/100

(57) ABSTRACT

In an information processing apparatus, a printer driver is activated (S1). When a watermark to be added to print data is selected (S2: YES), it is determined whether the watermark is linked to a confidential print processing while referring to a watermark setting table (S3). When it is determined that the watermark is linked to the confidential printing processing (S3: YES), it is determined whether confidential printing is set (S4). When it is determined that the confidential printing is not set (S4: NO), a state where the confidential printing is selected is displayed on a screen (S5), and a password input inbox for setting a password is displayed (S6). A user is thereby prompted to make a setting of the confidential printing.

### CROSS-REFERENCE TO RELATED APPLICATIONS

This Nonprovisional application claims priority under 35 U.S.C. §119(a) on Patent Application No. 2003-172511 filed in Japan on Jun. 17, 2003, the entire contents of which are hereby incorporated by reference.

### BACKGROUND OF THE INVENTION

1. Field of the Invention

The present invention relates to an information processing apparatus. More specifically, the present invention relates to an information processing apparatus which assures making settings for keeping secrecy of image data when processing the image data, and a computer program product for realizing the information processing apparatus by a general purpose computer system.

2. Description of the Related Art

Conventionally, as a printer driver which enables an information processing apparatus to control an image forming apparatus such as a printer apparatus or a multi-function printer (MFP), many printer drivers each having the function of printing a specific character string or image data on each page or a given page to be printed, referred to as “watermark function”, are put to practical use as products. The watermark function is employed to attract attention to dealing of a document to be printed, by inserting a character pattern such as “Top-secret”, “Important”, “Circulation”, “Urgent”, or “Do not Copy” into a document or the like to be printed (see, for example, Japanese Patent Application Laid-Open No. 2002-77600 (P2002-77600A)).

If the information processing apparatus carries out an ordinary print processing, data is often already printed and a printed matter is discharged before a user goes to an installation location of the image forming apparatus and takes the printed matter. As for an image forming apparatus which has a small number of paper discharge units (paper discharge trays), printed matters of a plurality of users are often discharged to the same paper discharge tray under mixture condition. With the image forming apparatus of this type; a printed-matter outputted by a certain user may be possibly, erroneously taken away by another user and a content of the printed matter may possibly be viewed by the another user. Such image forming-apparatus is therefore not suitable for printing of a secret document. Under these circumstances, some conventional printer drivers have the function referred to as “confidential printing function”. With the confidential printing function, each user registers his/her password on the printer driver, whereby the image forming apparatus does not print out print data and holds the print data therein until password authentication is performed, and starts printing the print data when the password is authenticated.

When the information processing apparatus into which the printer driver having the above-described two functions (the watermark function and the confidential printing function) are installed controls the image forming apparatus to print a document which is highly secret and needs to be dealt with carefully, it is desirable to add a character string such as “Top-secret” or “Important” to a document to be printed as a watermark using the watermark function, and to prevent a printed matter from being erroneously taken away or viewed by another user during printing using the confidential printing function.

Nevertheless, since the two functions are conventionally installed in the printer driver independently of each other, the prior art has the following disadvantage. Even if a watermark setting is made, the secrecy of the printed matter cannot be sufficiently assured when the user forgets setting the confidential printing function.

The prior art is confronted by the same disadvantage if the user does not recognize the presence of the confidential printing function itself, or even if the user recognizes the presence of the confidential printing function, he/she does not set the confidential printing function due to troublesomeness of the setting.

Furthermore, the image forming apparatus disclosed in the above-described prior art, P2002-77600A, is constituted to detect whether the print data received from the image processing apparatus includes specific characters or a specific graphic, to store the print data in storing means within the image forming apparatus in the case of detecting the specific characters or graphic, and to print the print data only when a user of the image data or an administrator permits printing the image data. The conventional image forming apparatus can therefore use only the characters or graphic registered in advance. However, needless to say that it is desirable to be able to optionally set usable characters or graphics according to a utilization environment of the image forming apparatus.

In addition, since this conventional image forming apparatus is constituted to store the print data in the storing means without printing the data on the basis of a determination by the image forming apparatus, it is difficult for the user to grasp whether the print data is stored in the storing means. As a result, the prior art has a disadvantage in that the print data is stored in the storing means and cannot be printed against user's intention. Besides, according to the prior art, in order to promptly print the print data without storing the print data in the storing means, it takes the user much labor such that the user must check the characters and graphic used in the print data.

### BRIEF SUMMARY OF THE INVENTION

The present invention is made in view of the above circumstances. According to the present invention, an information processing apparatus is constituted to comprise storing means for storing a plurality of pieces of additional information to be added to image data included in a job for instructing image forming, to receive selection of one information from among the plurality of pieces of information stored in the storing means, to determine whether the selected information is predetermined information, and to notify that it is necessary to execute a processing for assuring the secrecy of the image data when it is determined that the information is the predetermined information. It is an object of the present invention to provide an information processing apparatus which can assure secrecy of image data by prompting a user to make a setting of a processing for assuring the secrecy of the image data when predetermined information is added to the image data, and a computer program product for allowing such an information processing apparatus to be realized by a general purpose computer system, by adopting this constitution.

An information processing apparatus according to the present invention comprises: first receiving means for receiving whether a processing for assuring secrecy of image data to be formed as an image is necessary, job generating means for generating a job including the information received by the first receiving means, and for instructing forming image based on the image data to be formed as an image; and outputting means for outputting the job generated by the job generating means to other apparatus so that the other apparatus forms the image, and is characterized by further comprising: additional information storing means for storing a plurality of pieces of additional information to be added to the image data to be formed as an image; second receiving means for receiving selection of one additional information from among the plurality of pieces of additional information stored in the additional information storing means; determining means for determining whether the additional information the selection of which is received by the second receiving means is predetermined additional information; and means for notifying that it is necessary to execute the processing for assuring the secrecy of the image data when the determining means determines that the additional information is the predetermined additional information.

The information processing apparatus according to the present invention comprises the storing means for storing a plurality of pieces of additional information to be added to the image data included in a job for instructing image forming, receives selection of one additional information from among the plurality of pieces of additional information stored in the storing means, and notifies the user that a processing for assuring the secrecy of the image data to be formed as an image is necessary when the selected additional information is predetermined additional information. When the user makes an appropriate setting in accordance with this notification, the secrecy of the image data is assured. Therefore, if the user does not want the secrecy, the user can ignore the notification that the processing for assuring the secrecy of the image data is necessary. Thus, the processing for assuring the secrecy of the image data is not executed against user's intention.

The information processing apparatus according to the present invention is, in the abovementioned invention, characterized by further comprising: additional image data generating means for generating additional image data in accordance with the additional information the selection of which is received by the second receiving means; and synthesizing means for synthesizing the image data generated by the additional image data generating means with the image data to be formed as an image; whereby the job generating means generates a job for instructing the image forming based on the image data synthesized by the synthesizing means.

The information processing apparatus according to the present invention generates image data in accordance with the selected additional information, and synthesizes the generated image data with the image data included in the job. Therefore, a watermark can be adopted as the additional information added to the image data included in the job. When a specific watermark is selected, it is possible to prompt the user to make the setting of the processing for assuring the secrecy of the image data such as a confidential processing or an image data encryption processing. Thus, the user makes an appropriate setting in accordance with this notification, so that the secrecy of the image data is assured.

The information processing apparatus according to the present invention is, in each of the abovementioned invention, characterized in that the processing for assuring the secrecy of the image data is a processing for encrypting the image data to be formed as an image.

The information processing apparatus according to the present invention notifies the user that the image data encryption processing is necessary when the additional information added to the image data to be formed as an image is predetermined additional information. Therefore, the user makes an appropriate setting in accordance with this notification, so that the secrecy of the image data is assured.

The information processing apparatus according to the present invention is, in each of the abovementioned invention, characterized in that the processing for assuring the secrecy of the image data is a processing for receiving authentication information for instructing the other apparatus to start executing the image forming based on the job outputted from the outputting means.

The information processing apparatus according to the present invention notifies the user that a processing for receiving authentication information is necessary when starting execution of the image forming, that is, so-called confidential processing is necessary when the additional information added to the image data to be formed as an image is predetermined additional information. Therefore, the user makes an appropriate setting in accordance with this notification, so that the secrecy of the image data is assured.

The information processing apparatus according to the present invention is, in each of the abovementioned invention, characterized by further comprising: additional information receiving means for receiving additional information; and means for storing the additional information received by the additional information receiving means in the additional information storing means.

The information processing apparatus according to the present invention receives the additional information added to the image data on the image to be formed, and stores the additional information in the storing means. Therefore, it is possible to determine whether to prompt the user to make the setting of the processing for assuring the secrecy on the basis of the additional information optionally set by the user. Thus, the user can make a setting according to a utilization environment.

A computer program product according to the present invention for causing a computer to generate a job instructing a printer to perform printing on the basis of image data to be printed and information related to whether a processing for assuring secrecy of the image data is necessary. Such computer program product is characterized by comprising: a computer readable storage medium having computer readable program code means embodied in the medium, the computer readable program code means comprising instructions for: receiving an input of selection of one of a plurality of pieces of additional information as an input for designating the additional information added to the image data to be printed; determining whether the selected additional information is predetermined information; and outputting information indicating that it is necessary to execute the processing for assuring the secrecy when it is determined that the selected additional information is the predetermined information.

The computer program product according to the present invention allows the computer to execute a processing for receiving an input of selection of one of a plurality of pieces of additional information as an input for designating the additional information added to the image data to be printed, determining whether the selected additional information is predetermined information, and outputting information indicating that it is necessary to execute the processing for assuring the secrecy when it is determined that the selected additional information is the predetermined information, at the time of generating a job for instructing a printer to perform printing based on the image data to be printed and information related to whether a processing for assuring the secrecy of the image data is necessary.

The computer program product according to the present invention is, in the abovementioned invention, characterized in that the computer readable program code means further comprising instructions for: generating additional image data in accordance with the selected additional information; synthesizing the image data generated in accordance with the selected additional information with the image data to be printed; and generating a job for instructing the printing based on the synthesized image data.

The computer program product according to the present invention allows the computer to execute processings for generating additional image data in accordance with the selected additional information, synthesizing the generated image data with the image data to be printed, and generating a job for instructing the printing based on the synthesized image data.

The computer program product according to the present invention is, in the abovementioned invention, characterized in that the processing for assuring the secrecy of the image data is a processing for encrypting the image data.

The computer program product according to the present invention allows the computer to execute a processing for encrypting the image data as the processing for assuring the secrecy of the image data.

The computer program product according to the present invention is, in the abovementioned invention, characterized in that the processing for assuring the secrecy of the image data is a processing for receiving authentication information for instructing the printer to start executing the printing based on the generated job.

The computer program product according to the present invention allows the computer to execute a processing for receiving authentication information for instructing the printer to start executing the printing based on the generated job as the processing for assuring the secrecy of the image data.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing one example of connection state of an information processing apparatuses according to the present invention to an image forming apparatus;

FIG. 2 is a block diagram showing one example of internal configuration of an image processing apparatus according to the present invention;

FIG. 3 is a block diagram showing one example of internal configuration of an image forming apparatus connected to information processing apparatuses according to the present invention;

FIG. 4 is a schematic view showing one example of a setting screen of an information processing apparatuses according to the present invention when a printer driver is activated;

FIG. 5 is a schematic view showing details of a watermark selection portion displayed on the setting screen;

FIG. 6 is a schematic view showing one example of a screen of an information processing apparatuses according to the present invention used for adding a watermark;

FIG. 7 is a conceptual view showing one example of registered contents of a watermark setting table of an information processing apparatuses according to the present invention;

FIG. 8 is a schematic view showing one example of a setting screen activated by the printer driver of an information processing apparatuses according to the present invention;

FIG. 9 is a schematic view showing one example of a job management screen for setting details of a print job of an information processing apparatuses according to the present invention;

FIG. 10 is a schematic view showing one example of a job management screen for setting details of the print job of an information processing apparatuses according to the present invention;

FIG. 11 is a flowchart showing processing procedure for generating a print job of an information processing apparatuses according to the present invention; and

FIG. 12 is a flowchart showing processing procedure for generating the print job of an information processing apparatuses according to the present invention:

### DETAILED DESCRIPTION OF THE PREFERRED EMBODIMENTS

The present invention will be specifically described hereinafter with reference to the drawings showing embodiments of the present invention.

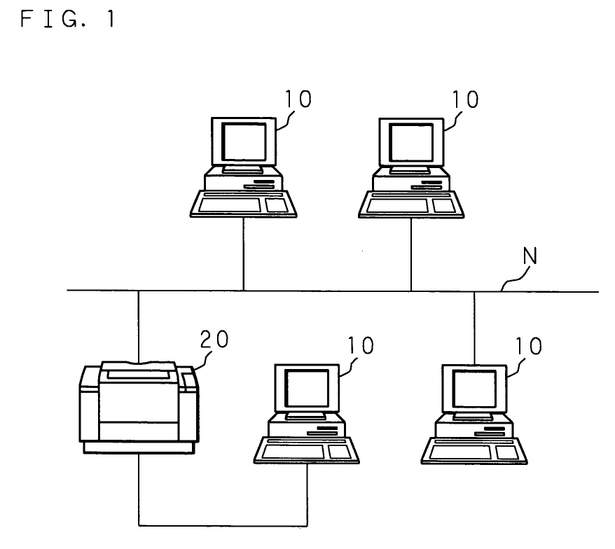

FIG. 1 is a schematic view showing one example of connection state of information processing apparatuses according to the present invention to an image forming apparatus. In FIG. 1, reference numeral 10 denotes an information processing apparatus according to the present invention. Specifically, the information processing apparatus 10 is a general purpose computer system such as a personal computer or a workstation. Most of the plurality of information processing apparatuses 10 are connected to the image forming apparatus (e.g., a printer apparatus or a multi-function printer) 20 through a communication network N. A part of the information processing apparatuses 10 are directly connected to the image forming apparatus 20 without using the communication network N.

A computer program (printer driver) according to the present invention for ensuring connection between each information processing apparatus 10 and the image forming apparatus 20, and for using the image forming apparatus 20 via the communication network N is installed in each of the information processing apparatuses 10 in advance. This printer driver is activated by optional application programs for creating document, graphics and the like, and generates a print job on the basis of data that a user desires to print. The generated print job is transmitted to the image forming apparatus 20 designated by the printer driver. In FIG. 1, only one image forming apparatus 20 is shown. Alternatively, a plurality of image forming apparatuses 20 may be connected to the communication network N.

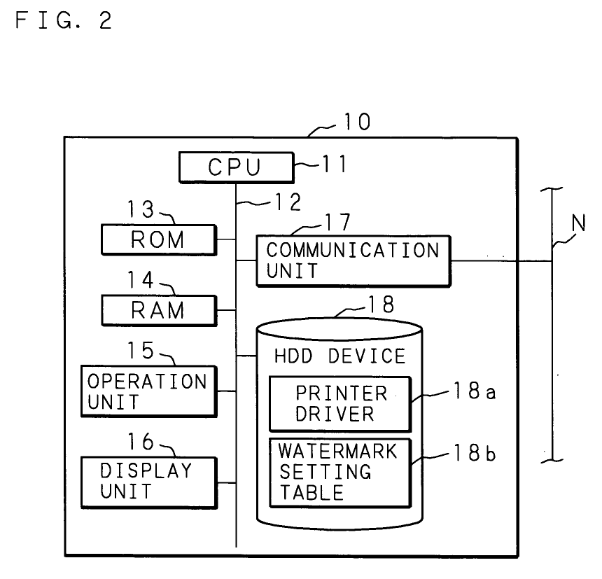

When the printer driver is activated, a setting screen for making various settings in relation to generation and transmission of the print job is displayed on a display unit 16 (see FIG. 2) of the information processing apparatus 10. Contents which can be set on this setting screen include ordinary settings such as an output destination of a printed matter (the image forming apparatus 20 or, if a plurality of imaging forming apparatuses 20 are present, one of the imaging forming apparatuses 20), the number of print pages, the number of prints, a sheet size, and a type of the sheet, as well as settings of processings for assuring the secrecy of the print data such as a confidential processing and an encryption processing.

Further, a setting of a watermark added to the print data is made by the printer driver. The watermark is a mark which the user can optionally add to the print data, and includes a character string such as “Important”, “Top-secret”: “Secrete from outsiders”, “Circulation, or “Urgent”. When the watermark is set by the printer driver, the information processing apparatus 10 synthesizes image data to be printed, which is designated by the user, with image data designated as the watermark, and generates a print job on the basis of the resultant synthesized image.

When the watermark including the character string such as “Important”, “Top-secret”, or “Secrete from outsiders” is added to the print data, this means that the print data has the secrecy. Therefore, it is desirable to set-the processings for assuring the secrecy of the print data such as the confidential processing and the encryption processing besides the addition of the watermark. To this end, the information processing apparatus 10 according to the present invention is constituted to make display for prompting the user to make settings of the processing for assuring the secrecy of the print data when the addition of the watermark including the character string which implies that the print document has secrecy is set to the print data.

FIG. 2 is a block diagram showing one example of internal configuration of the information processing apparatus 10. The information processing apparatus 10 includes a CPU 11. Hardware such as a ROM 13, a RAM 14, an operation unit 15, the display unit 16, a communication unit 17, and an HDD device 18 are connected to the CPU 11 through a bus 12. The CPU 11 temporarily loads a necessary portion of a control program stored in the ROM 13 in advance to the RAM 14, reads the necessary portion from the RAM 14, and executes the necessary portion, thereby controlling the various hardware described above. The RAM 14 is a volatile memory, and temporarily stores various pieces of data generated while the CPU 11 executes the control program, data inputted from the outside through the operation unit 15, the communication unit 17 and the like, data, computer program, and the like read from the HDD device 18.

The operation unit 15 is constructed by input devices such as a keyboard, a mouse or a tablet, and receives user's instructions for various processings. The display unit 16 is a display device such as a CRT display or a liquid crystal display, and displays the data inputted through the operation unit 15 and the various pieces of data generated in response to the instruction of the CPU 11. The communication unit 17 has a communication interface conformal to the communication network N, transmits the print job generated within the information processing apparatus 10 to the image forming apparatus 20 through the communication network N, and receives various pieces of information transmitted from the image forming apparatus 20. The communication unit 17 controls transmission and reception of the information through the communication network N.

The HDD device 18 is a nonvolatile memory device including a disk-shaped magnetic recording medium, and a part of a storage area thereof stores a printer driver 18a and a watermark setting table 18b. The printer driver 18a executes various settings for ensuring the connection between the information processing apparatus 10 and the image forming apparatus 20, the generation of the print job based on a user's instruction inputted from the operation unit 15, and the transmission of the print job to the image forming apparatus 20 through the communication unit 17. The watermark setting table 18b stores a plurality of watermarks which can be set by the printer driver 18a and information on the processings recommended to be set so as to correspond to the respective watermarks while making them correspond to one another.

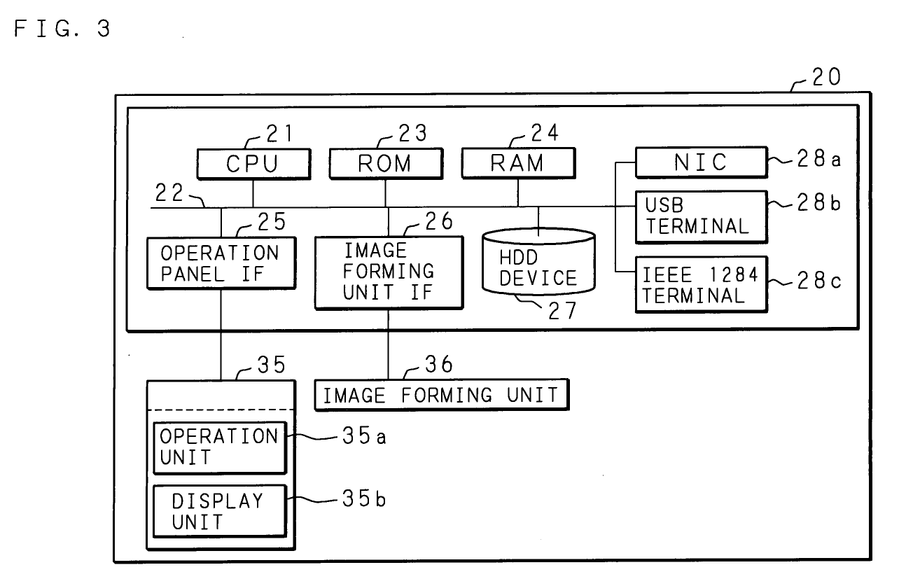

FIG. 3 is a block diagram showing one example of internal configuration of the image forming apparatus 20. The image forming apparatus 20 includes a CPU 21. Hardware such as a ROM 23, a RAM 24, an operation panel interface (IF) 25, an image forming unit IF 26, an HDD device 27, a network interface card (NIC) 28a, a universal serial bus (USB) terminal 28b, and an IEEE1284 terminal 28c are connected to the CPU 21 through a bus 22. The ROM 23 stores a control program for controlling abovementioned hardware by the CPU 21. The CPU 21 temporarily loads a necessary portion of the control program to the RAM 24 and reads the necessary portion from the RAM 24 for execution, thereby controlling the respective hardware. The CPU 21 also controls an operation panel 35 through the operation panel IF 25 and controls an image forming unit 36 through the image forming unit IF 26. The RAM 24 is a volatile memory and temporarily stores various pieces of data generated while the CPU 21 executes the control program, image data obtained by expanding the print job inputted through the NIC 28a, the USB terminal 28b and the IEEE1284 terminal 28c, and the like.

The operation panel 35 includes an operation unit 35a which receives operation instructions from the user, and a display unit 35b which displays set values inputted through the operation unit 35a. The operation unit 35a includes operation keys for receiving an operation for switching the functions of the image forming apparatus 20 and changes in settings such as the number of prints and a concentration adjustment. The display unit 35b includes a display device such as a liquid crystal display device or an LED display device, and displays various set values set by the operation unit 35a. The display unit 35b may also serve as the operation unit 35a by providing a touch panel type software key on a portion of the display unit 35b so as to receive various settings.

The NIC 28a includes a communication interface conformal to a protocol for the communication network N. The NIC 28a can receive data such as the print job from the information processing apparatus 10, and transmit various pieces of data to the information processing apparatus 10 if necessary. By using a USB cable and a parallel cable as the USB terminal 28b and the IEEE1284 terminal 28c, respectively, the image forming apparatus 20 can be directly connected to the information processing apparatus 10.

The HDD device 27 is a nonvolatile memory device including a disk-shaped magnetic recording medium, and temporarily stores the print job received through the NIC 28a, the USB terminal 28b and the IEEE1284 terminal 28c.

The image forming unit, 36 is an electrophotographic printer that includes, for example, a charger which charges a photosensitive drum with a predetermined potential, a laser writing unit which irradiates the photosensitive drum with a laser light in accordance with image data received from the outside to generate an electrostatic latent image, a developer which supplies toner to the electrostatic latent image formed on a surface of the photosensitive drum to form a toner developed image, a transfer unit which transfers the toner developed image formed on the surface of the photosensitive drum onto a sheet (all of the constituent elements are not shown), and the like. The image forming unit 36 forms a user's desired image on the sheet, and outputs the resultant sheet.

In this embodiment, the image forming unit 36 is constituted to form an image by electrophotography using the laser wiring unit. It is needless to say that the image forming unit 36 may be constituted to form an image by inkjet printing, thermal transfer or sublimation.

An operation for setting the watermark using the printer driver 18a installed in the information processing apparatus 10 will be described with reference to the schematic view showing examples of a screen of the display unit 16.

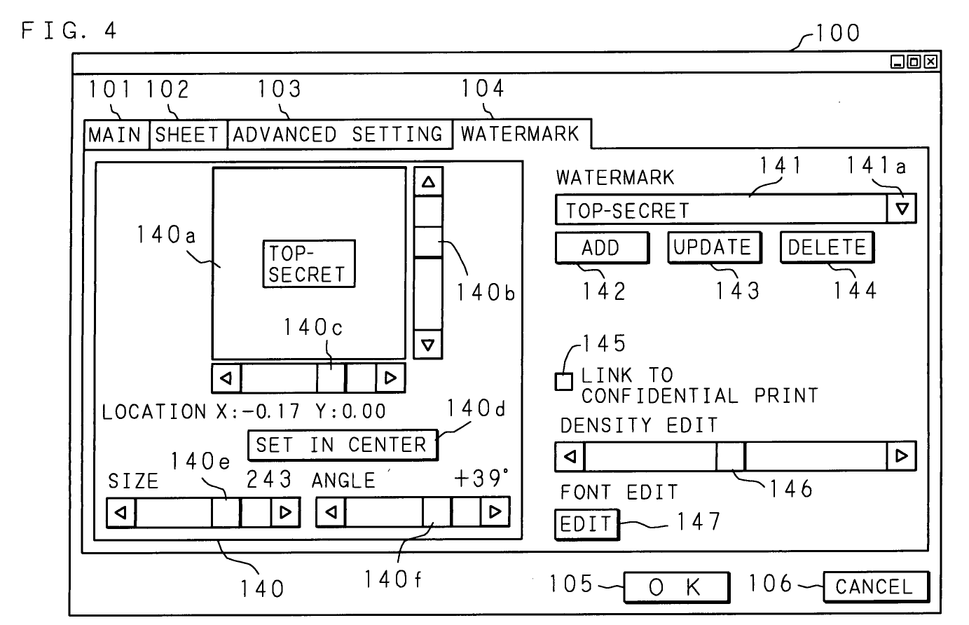

FIG. 4 is a schematic view showing one example of a setting screen when the printer driver 18a is activated. When the printer driver 18a installed in the HDD device 18 of the information processing apparatus 10 is activated, a setting screen 100 shown in the schematic view of FIG. 4 is displayed first on the display unit 16.

On this setting screen 100, while various settings can be made using the mouse, the keyboard or the like included in the operation unit 15, contents to be set can be changed according to plural tags 101 to 104 by switching the tags 101 to 104. For example, a basic setting related to a print processing can be made on a main setting screen designated by the tag 101. A setting related to the type of sheet to be used can be made on a sheet setting screen designated by the tag 102. A setting of processings for assuring the secrecy of the print job and the like can be made on an advanced setting screen designated by the tag 103. A setting of a processing related to the watermark can be made on a screen designated by the tag 104.

An execution (OK) button 105 and a cancel button 106 are provided at lower portion of the setting screen 100. After the various settings are made on the respective screens, when the execution button 105 is selected by an operation of the operation unit 15, a print job is generated on the basis of setting contents at that moment and is transmitted to the image forming apparatus 20. When the cancel button 106 is selected, the processing performed by the printer driver 18a is terminated without generating the print job.

Meanwhile, FIG. 4 shows the example of the screen for setting the watermark displayed when the tag is changed to the tag 104. Displayed on this screen are a watermark setting portion 140 which sets a size, a position and the like of the watermark to be synthesized with the image data to be printed, and a watermark selection portion 141 which selects a type of the watermark to be synthesized with the image data.

The watermark selection portion 141 includes a pull-down button 141a. By depressing this pull-down button 141a, all of or some of selectable watermarks are displayed and subjected to user's selection. A selected watermark is schematically displayed on a preview display portion 140a of the watermark setting portion 140. At the preview display portion 140a, slider buttons 140b and 140c in parallel to a right edge and a lower edge of the preview display portion 140a are displayed, respectively. By sliding the slider buttons 140b and 140c, a synthesized position of a watermark on the image data to be printed can be adjusted. In addition, when a reset button 140d is depressed, the position of the watermark is set at the center portion of the image data to be printed. The watermark setting portion 140 includes a slider button 140e for adjusting the size of the watermark, and a slider button 140f for adjusting an inclination (rotational angle) of the watermark.

An add button 142, an update button 143 and a delete button 144 are prepared below the watermark setting portion 141. A new watermark can be registered (additionally registered) by the add button 142. An already registered watermark can be corrected and updated by the update button 143. The already registered watermark can be deleted by the delete button 144. Further, the concentration of the watermark to be synthesized with the image data can be adjusted by a slider button 146, and a font used for the watermark can be changed by a font edit button 147.

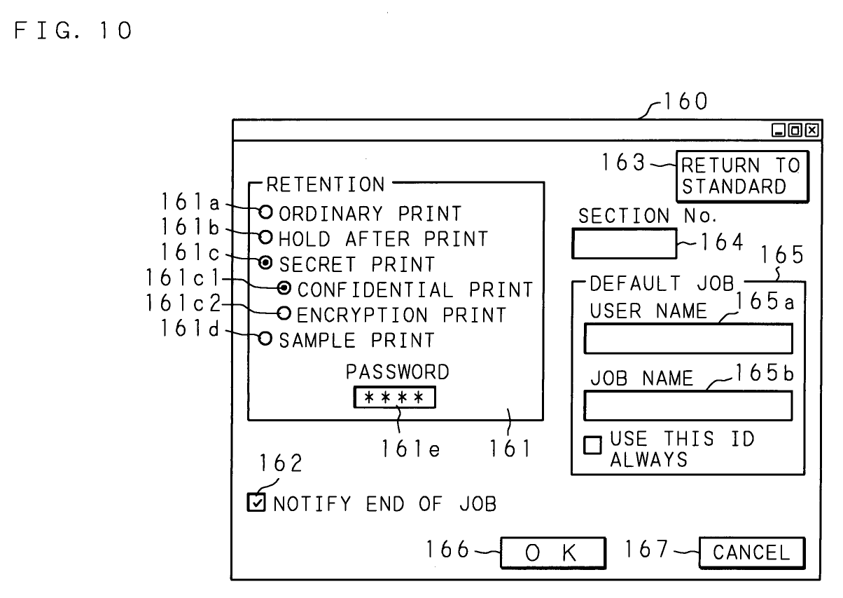

In this embodiment, a checkbox 145 is prepared for setting whether the watermark setting and the confidential printing function are to be linked with each other. Under checking condition of the checkbox 145, when the watermark which signifies that the print data has secrecy, specifically, the watermark including the character string such as “Top-secret” or “Important” is selected by the watermark selection portion 141, the setting of the processing for assuring the secrecy of the image data, i.e., display for prompting the user to make the confidential printing setting is made (see FIG. 10).

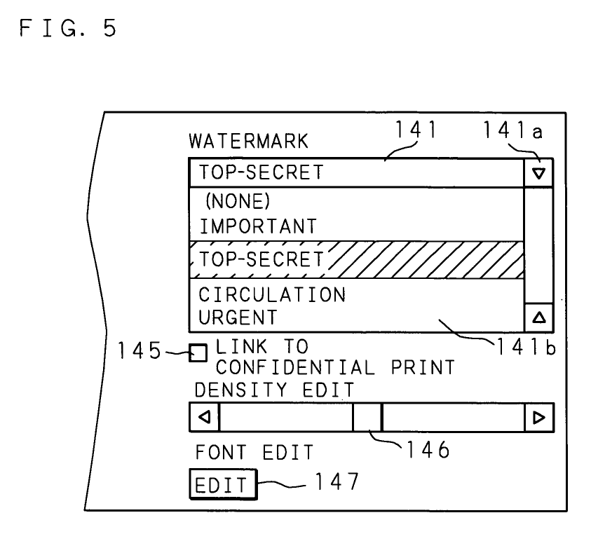

FIG. 5 is a schematic view showing details of the watermark selection portion 141. When the pull-down button 141a included in the watermark selection portion 141 is depressed, all of or a plurality of selectable watermarks are displayed on a pull-down menu 141b. The displayed watermarks can be optionally selected by the user using the operation unit 15. The selected watermark is displayed in the watermark selection portion 141 and in the preview display portion 140a shown in FIG. 4. When “None” is selected as the watermark, the selection of the watermark is released.

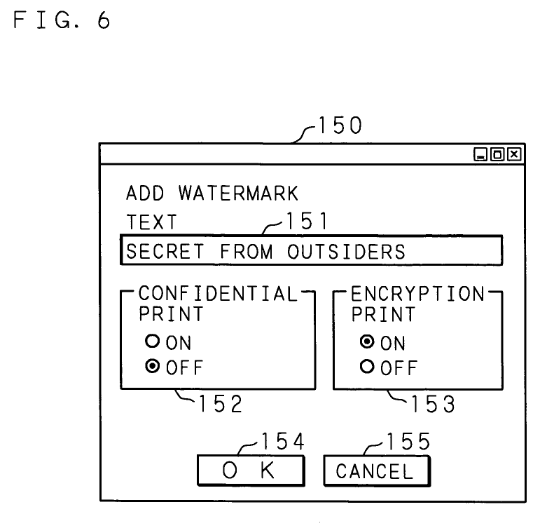

FIG. 6 is a schematic view showing one example of a screen for adding a watermark. When the add button 142 is selected on the setting screen 100 shown in FIG. 4, an addition screen 150 shown in FIG. 6 is displayed. On this addition screen 150, the user can optionally add an available watermark. The addition screen 150 includes a text input box 151, a confidential printing setting box 152, an encryption printing setting box 153, an execution (OK) button 154 and a cancel button 155.

Using the keyboard included in the operation unit 15, the user can input a character string to be added as a watermark to the text input box 151. The confidential printing setting box 152 includes selection buttons for receiving a selection setting as to whether the confidential printing is to be executed when the watermark inputted to the text input box 151 by the user is selected as the watermark to be synthesized with the image data to be printed. The encryption setting box 153 includes selection buttons for receiving a selection setting as to whether the data which has been subjected to the printing processing is to be encrypted and stored in the image forming apparatus 20.

The character string data inputted to the text input box 151, the setting information as to whether to execute the confidential printing inputted from the confidential printing setting box 152, and the setting information as to whether to encrypt the image data inputted from the encryption setting box 153 are registered in the watermark setting table 18b in the HDD device 18 when the execution button 154 is depressed. When one watermark is selected in the watermark selection portion 141 on the setting screen 100 shown in FIG. 4, the CPU 11 of the information processing apparatus 10 reads information on the selected watermark and the information corresponding (linked) to the watermark information from the watermark setting table 18b. When the read information indicates that the setting of executing the confidential printing is made, the display for prompting the user to make the setting for the confidential printing processing is made. When the information indicates that the setting of the encryption of the image data is made, the display for prompting the user to make the setting of encryption is made.

When the cancel button 155 is depressed, the watermark addition processing is terminated without registering new information in the watermark setting table 18b.

Further, on the watermark setting screen 100 shown in FIG. 4, when the update button 143 is depressed, the same screen as the addition screen 150 is displayed on the display unit 16. In this case, a change of the watermark, a change in the information for selection of the setting as to whether the confidential printing processing is necessary, and a change in the information for selection of the setting as to whether the encryption processing is necessary are received.

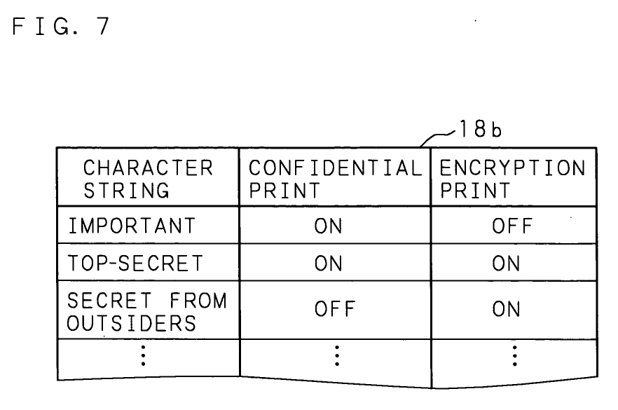

FIG. 7 is a conceptual view showing one example of registered contents of the watermark setting table 18b. The watermark setting table 18b stores information on character strings representing the respective watermarks, the information as to whether the confidential processing is necessary, and the information as to whether the encryption processing is necessary while making them correspond (linked) to one another. In the example shown in FIG. 7, information indicating that the confidential processing is necessary and the information indicating that the encryption processing is unnecessary are registered in the watermark setting table 18b while making the information correspond to the watermark including the character string of “Important”. Accordingly, when the watermark including the character string of “Important” is selected on the setting screen 100, the screen for setting the confidential printing processing is automatically displayed on the display unit 16, thereby prompting the user to make the setting. Likewise, the watermark including the character string of “Top secret” signifies that the print data is highly secret. Therefore, when the watermark including the character string of “Top-secret” is selected on the setting screen 100, the information indicating that the confidential processing is necessary and the information indicating that the encryption processing is necessary are registered. In addition, the watermark including the character string of “Secrete from outsiders” signifies that it is necessary to prevent the print data from being leaked to the outsiders of the company. Therefore, when the watermark including the character string of “Secrete from outsiders” is selected, the information indicating that the confidential processing is unnecessary but the encryption processing is necessary is registered.

The processings carried out when the information processing apparatus 10 generates a print job and transmits it to the image forming apparatus 20 will be described with reference to one example of a screen displayed by the printer driver 18a on the display unit 16.

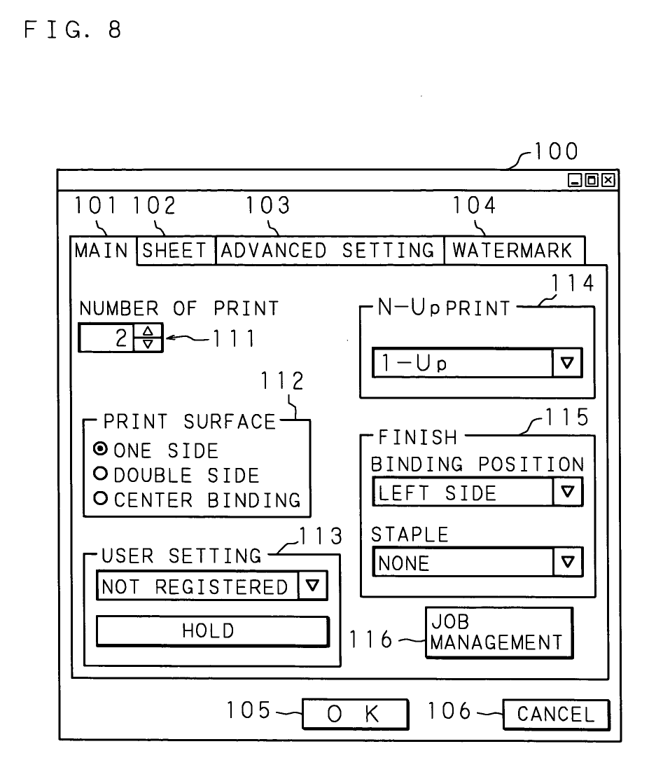

FIG. 8 is a schematic view showing one example of the setting screen 100 displayed on the display unit 16 of the information processing apparatus 10 when the printer driver 18a is activated. As already described, on the setting screen 100, the various settings can be made by switching the plural tags 101 to 104. On the main setting screen designated by the tag 101, basic settings related to the print processing can be received.

The main setting screen shown in FIG. 8 includes a number-of-prints setting box 111 for receiving an input of the number of prints, a printed surface selection box 112 for receiving selection of a printed surface, a user setting box 113 for storing contents set by the user, a layout setting box 114 for setting the number of pages printed in one print sheet, a finishing setting box 115 for setting stapling, and a job management button 116 for setting details of the print job.

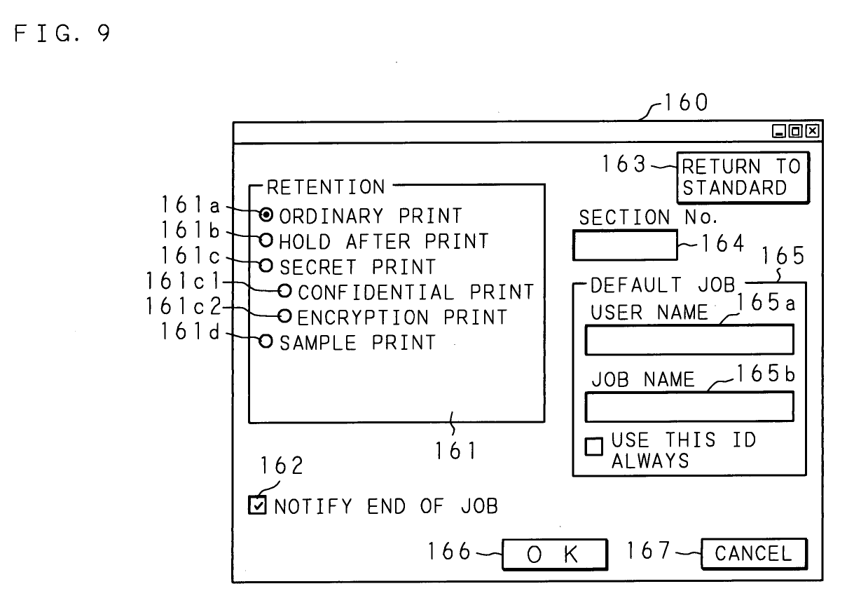

FIG. 9 and FIG. 10 are schematic views showing one example of the job management screen for setting the details of the print job. When the job management button 116 is depressed on the main setting screen shown in FIG. 8, a job management screen 160 shown in FIG. 9 is displayed on the display unit 16.

The job management screen 160 includes a retention setting portion 161. This retention setting portion 161 can make a selection as to whether ordinary printing is to executed, the print job is to be held after printing, secret printing (the confidential printing or encryption printing for holding the image data without printing it) is to be executed, or sample image printing is to be executed, by selecting one of radio buttons 161a to 161d displayed in the retention setting portion 161.

When the radio button 161a is selected, for example, the print job for allowing the image forming apparatus 20 to execute the print processing is generated and transmitted to the image forming apparatus 20, and the ordinary print processing is executed.

When the radio button 161b is selected, the print job for instructing the printed image data to be held in the image forming apparatus 20 is generated. In this case, the user can reuse the image data held in the image forming apparatus 20 without generating new image data. Accordingly, after one print processing is terminated, another print processing can be carried out using the same image data.

When the radio button 161c is selected, the print job for instructing the secret printing is generated. As described above, this secret printing includes the confidential processing and the encryption processing for holding the image data without printing it. While the radio button 161c is selected, one of or both of sub buttons 161c1 and 161c2 can be selected. When the sub button 161c1 is selected, the print job for instructing the confidential processing is generated. Specifically, a print job which is transmitted to the image forming apparatus 20 and temporarily stored in the HDD device 27, and instructs the print processing to be started only when the user is authenticated is generated. When the sub button 161c2 is selected, a print job for instructing the encryption processing is generated. Specifically, a print job which is transmitted to and printed by the image forming apparatus 20, and instructs encryption processing and storing itself in the HDD device 27 is generated.

When the radio button 161d is selected, a print job is generated on the basis of sample image data prepared by the printer driver 18a in advance, and transmitted to the image forming apparatus 20, and the image forming apparatus 20 executes a print processing using the sample image.

Furthermore, on the job management screen 160, not only the abovementioned retention setting portion 161 but also a checkbox 162 for notifying the user of the end of the print job, a reset button 163 for returning contents inputted to the job management screen 160 to a standard state, a section number input box 164 for inputting a section number (number for specifying a section in an organization to which the user belongs), and a job setting portion 165 which includes a user name input box 165a for inputting a default user name and a job name input box 165b for inputting a job name are displayed.

An execution (OK) button 166 and a cancel button 167 are arranged in a lower portion of the job management screen 160. When the execution button 166 is depressed, the contents set on the job management screen 160 are stored in a predetermined storage area of the HDD device 18. When the cancel button 167 is depressed, the job management screen 160 is closed without storing the contents set on the job management screen 160.

In this embodiment, when the watermark such as “Important” or “Top-secret” is selected from among the watermarks already registered, that is, the watermark, for which information indicating that the confidential processing is to be executed is registered to correspond to the watermark, is selected in the watermark setting table 18b, the job management screen 160 shown in FIG. 10 is displayed. On this job management screen 160, the radio button 161c for setting the secret printing and the sub button 161c1 for setting the confidential processing are automatically selected, and a password input box 161e is automatically displayed in the retention setting portion 161, thereby prompting the user to input user's password. Accordingly, the user inputs the password in the password input box 161e and depresses the execution (OK) button 166 on the job management screen 160 shown in FIG. 10 while keeping a state where the radio button 161c and the sub button 161c1 are selected, the confidential processing is set. It is noted that the password inputted to the password input box 161e is used by the image forming apparatus 20 for user authentication when the printing by the confidential processing is executed.

Further, when the watermark such as “Top-secret” or “Secrete from outsiders” is selected from among the already registered watermarks, that is, the watermark, for which information indicating that the encryption processing is to be executed is registered to correspond to the watermark, is selected in the watermark setting table 18b the radio button 161c for setting the confidential printing and the sub button 161c2 for setting the encryption processing are automatically selected in FIG. 10. In this case, similarly to the-confidential processing, when the user depresses the execution (OK) button 166 while keeping a state where the radio button 161c and the sub button 161c2 are selected, the encryption processing is set.

While the radio button 161c is selected, the sub buttons 161c1 and 161c2 can be simultaneously selected. When the sub buttons 161c1 and 161c2 are simultaneously selected, the password input box 161e for prompting the user to input user's password is automatically displayed in the retention setting portion 161.

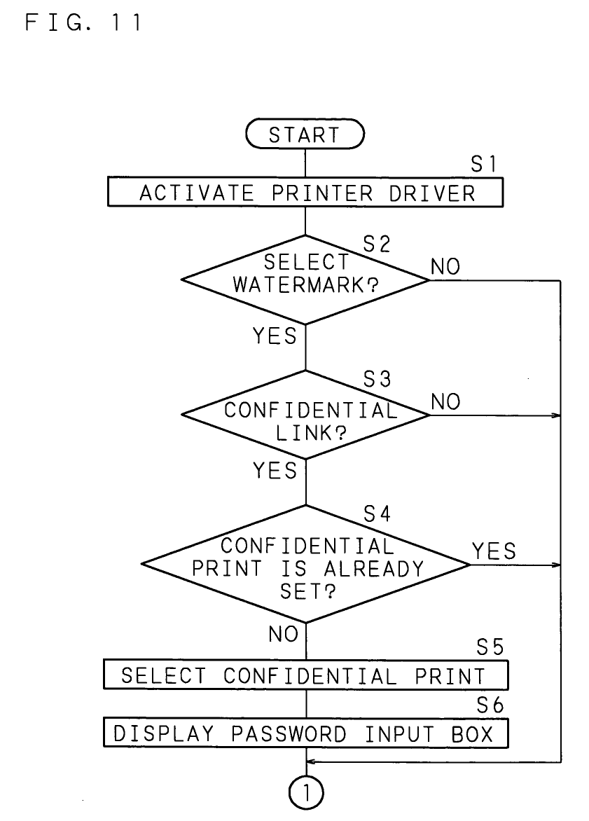

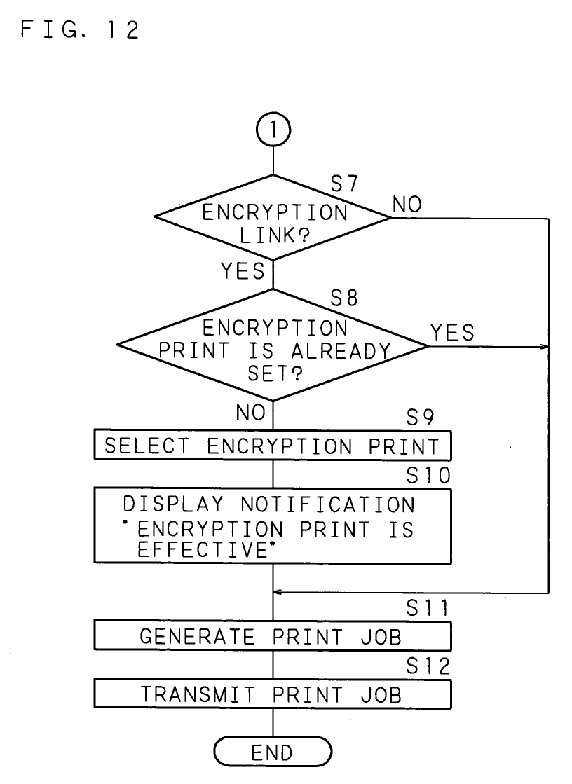

FIG. 11 and FIG. 12 are flowcharts showing processing procedure for generating a print job in the information processing apparatus 10. When the printer driver 18a installed in the HDD device 18 of the information processing apparatus 10 is activated (step S1), in the case where the printer driver 18a generates a print job, the CPU 11 determines whether the watermark to be included in the print job to be generated is selected (step S2). Specifically, the CPU 11 determines whether one watermark is selected from the watermark selection portion 141 on the setting screen 100 displayed on the display unit 16 by the printer driver 18a.

When the watermark is not selected (“NO” in step S2), the CPU 11 moves the processing to step S7 described later.

When the watermark is selected (“YES” in step S2), the CPU 11 determines whether a confidential link is designated to the selected watermark, that is, whether the information indicating that the confidential processing is to be executed is registered to correspond to the watermark setting table 18b (step S3).

When it is determined that the confidential link is not designated (“NO” in step S3), the CPU moves the processing to step S7.

When it is determined that the confidential link is designated (“YES” in step S3), the CPU 11 determines whether a confidential setting is already made (step S4). The determination as to whether the confidential setting is already made is based on determination as to whether the radio button 161c is selected and the password is inputted in the password input box 161e on the job management screen 160.

When it is determined that the confidential setting is already made (“YES” in step S4), the CPU 11 moves the processing to step S7.

When it is determined that the confidential setting is not made yet (“NO” in step S4), the CPU 11 selects both the radio button 161c and the sub button 161c1 for selecting and setting the confidential printing on the job management screen 160 (step S5), and displays the password input box 161e for prompting the user to input user's password (step S6). Then, the CPU 11 determines whether an encryption link is designated to the selected watermark, that is, the information indicating that the encryption printing is to be executed is registered to correspond to the watermark setting table 18b (step S7).

When it is determined that the encryption link is not designated (“NO” in step S7), the CPU 11 moves the processing to step S11 and carries out the print job generation processing and the print job transmission processing (step S12).

When it is determined that the encryption link is designated (“YES” in step S7), the CPU 11 determines whether an encryption setting is already made (step S8). When it is determined that the encryption setting is already made (“YES” in step S8), the CPU 11 moves the processing to step S11 and carries out the print job generation processing and the print job transmission processing (step S12).

When it is determined that the encryption setting is not made yet (“NO” in step S8), the CPU 11 selects both the radio button 161c and the sub button 161c2 for selecting and setting the encryption processing on the job management screen 160 (step S9), and displays a notification (not shown) for notifying the user that the encryption printing is effective on the display unit 16 (step S10). The CPU 11 generates a print job in accordance with the contents set on the setting screen 100 and the job management screen 160 prepared by the printer driver 18a, and transmits the generated print job to the image forming apparatus 20.

As can be understood, in this embodiment, the user is prompted to set the confidential printing processing or the encryption printing processing, or to set both processing in accordance with the selected watermark. It is therefore possible to prevent the user from forgetting making these settings and possible to assure the secrecy of the print data.

In this embodiment, whether to successively perform the selection of the watermark and the confidential printing function can be optionally set by the user using the checkbox 145 on the setting screen 100 prepared by the printer driver 18a. It is needless to say that the selection of the watermark and the confidential printing function may be forced to be linked. Specifically, the checkbox 145 is not displayed, that is, the user is not permitted to make a setting as to, whether the selection of the watermark and the confidential printing function are to be linked. In this case, when the watermark for which the information indicating that “the confidential printing is to be executed” is registered, that is, the watermark for which the information indicating that the confidential processing is necessary is designated in the watermark setting table 18b on the addition screen 150 for adding the watermark shown in FIG. 6, the job management screen 160 shown in FIG. 10 can be set to be always displayed so as to receive the setting related to the confidential processing.

In this embodiment, the character string is selected as the watermark. It is needless to say that image data such as image data prepared in advance by the printer driver 18, or image data optionally created by the user may be selected.

As described above in detail, the information processing apparatus according to the present invention notifies the user to prompt the user to make settings of the processings such as the confidential printing and the image data encryption when the specific watermark such as “Top-secret” or “Secrete from outsiders” is selected as the additional information to be added to the image data included in the job which instructs image forming. By allowing the user to appropriately make settings in accordance with this notification, the secrecy of the image data can be assured. However, when the user does not want to assure the secrecy of the image data, the user can ignore the notification that the processings for assuring the secrecy of the image data are necessary. Therefore, the processings for assuring the secrecy of the image data are not executed against the user's intention.

Further, the information processing apparatus according to the present invention can adopt the watermark as the additional information added to the image data included in the job. When the specific watermark is selected, it is possible to prompt the user to make the settings of the processings such as the confidential processing and the image data encryption. The secrecy of the image data can be therefore assured.

Moreover, the information processing apparatus according to the present invention notifies the user that the image data encryption is necessary when the additional information added to the image data is a predetermined watermark. The secrecy of the image data can be therefore assured.

Additionally, the information processing apparatus according to the present invention notifies the user that the processing for receiving authentication information is necessary when starting executing the image forming in the case where the additional information added to the image data is a predetermined watermark. The secrecy of the image data outputted by prompting the user to make the setting of the so-called confidential processing can be therefore assured.

Furthermore, the information processing apparatus according to the present invention receives the watermark as the additional information to be added to the image data and stores the received watermark in the storing means. Therefore, it is possible to determine whether to prompt the user to make the settings for assuring the secrecy on the basis of the watermark optionally set by the user, and to make settings according to the utilization environment.

In addition, the computer program product according to the present invention can realize the invention of the above-described information processing apparatus by the general purpose computer.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An information processing apparatus comprising: first receiving means for receiving whether a processing for assuring secrecy of image data to be formed as an image is necessary; job generating means for generating a job including said information received by said first receiving means, and for instructing forming image based on said image data to be formed as an image; and outputting means for outputting the job generated by said job generating means to other apparatus so that the other apparatus forms the image, said information processing apparatus further comprising:
additional information storing means for storing a plurality of pieces of additional information to be added to said image data to be formed as an image;
second receiving means for receiving selection of one additional information from among the plurality of pieces of additional information stored in said additional information storing means;
determining means for determining whether the additional information the selection of which is received by said second receiving means is predetermined additional information; and
means for notifying that it is necessary to execute said processing for assuring the secrecy of the image data when said determining means determines that the additional information is the predetermined additional information.

2. The information processing apparatus as set forth in claim 1, further comprising:
additional information receiving means for receiving additional information; and
means for storing the additional information received by said additional information receiving means in said additional information storing means.

3. The information processing apparatus as set forth in claim 1, wherein said processing for assuring the secrecy of said image data is a processing for receiving authentication information for instructing said other apparatus to start executing the image forming based on the job outputted from said outputting means.

4. The information processing apparatus as set forth in claim 1, wherein said processing for assuring the secrecy of said image data is a processing for encrypting the image data to be formed as an image.

5. The information processing apparatus as set forth in claim 1, further comprising:
additional image data generating means for generating additional image data in accordance with the additional information the selection of which is received by said second receiving means; and
synthesizing means for synthesizing the image data generated by said additional image data generating means with said image data to be formed as an image;
whereby said job generating means generates a job for instructing the image forming based on the image data synthesized by said synthesizing means.

6. The information processing apparatus as set forth in claim 5, further comprising:
additional information receiving means for receiving additional information; and
means for storing the additional information received by said additional information receiving means in said additional information storing means.

7. The information processing apparatus as set forth in claim 5, wherein said processing for assuring the secrecy of said image data is a processing for receiving authentication information for instructing said other apparatus to start executing the image forming based on the job outputted from said outputting means.

8. The information processing apparatus as set forth in claim 1, wherein said processing for assuring the secrecy of said image data is a processing for encrypting the image data to be formed as an image.

9. An information processing apparatus comprising: a display unit; an operation unit for receiving whether a processing for assuring secrecy of image data to be formed as an image is necessary; a communication unit for communicating with other apparatus; a storing unit for storing a plurality of pieces of additional information to be added to said image data to be formed as an image; a processor for generating a job including said information received by said operation unit, and for instructing image forming based on said image data to be formed as an image and for outputting the generated job to other apparatus through said communication unit so that the other apparatus forms the image;
wherein said processor is connected to said display unit, said operation unit, said communication unit and said storing unit, and is capable of performing the following operations of:
causing said operation unit to receive selection of one additional information from among the plurality of pieces of additional information stored in said storing means;
determining whether the additional information the selection of which is received by said operation unit is predetermined additional information; and
displaying on said display unit that it is necessary to execute processing for assuring the secrecy of the image data when said additional information is the predetermined additional information.

10. The information processing apparatus as set forth in claim 9, wherein said processor is further capable of performing the following operations of:
causing said operation unit to receive inputting of an additional information; and
storing the additional information received by said operation nit in said storing unit.

11. The information processing apparatus as set forth in claim 9, wherein said processing for assuring the secrecy of said image data is a processing for receiving authentication information for instructing said other apparatus to start executing the image forming based on the job outputted from said communication unit.

12. The information processing apparatus as set forth in claim 9, wherein said processing for assuring the secrecy of said image data is a processing for encrypting the image data to be formed as an image.

13. The information processing apparatus as set forth in claim 9, wherein said processor is further capable of performing the following operations of:
generating additional image data in accordance with the additional information the selection of which is received by said operation unit;
synthesizing the generated additional image data with said image data to be formed as an image; and
generating a job for instructing the image forming based on the synthesized image data.

14. The information processing apparatus as set forth in claim 13, wherein said processor is further capable of performing the following operations of:
causing said operation unit to receive inputting of an additional information; and
storing the additional information received by said operation nit in said storing unit.

15. The information processing apparatus as set forth in claim 13, wherein said processing for assuring the secrecy of said image data is a processing for receiving authentication information for instructing said other apparatus to start executing the image forming based on the job outputted from said communication unit.

16. The information processing apparatus as set forth in claim 13, wherein said processing for assuring the secrecy of said image data is a processing for encrypting the image data to be formed as an image.

17. A computer program product for causing a computer to generate a job instructing a printer to perform printing on the basis of image data to be printed and information related to whether a processing for assuring secrecy of the image data is necessary, wherein the computer program product comprises:
a computer readable storage medium having computer readable program code means embodied in said medium, said computer readable program code means comprising instructions for:
receiving an input of selection of one of a plurality of pieces of additional information as an input for designating the additional information added to the image data to be printed;
determining whether the selected additional information is predetermined information; and
outputting information indicating that it is necessary to execute said processing for assuring the secrecy when it is determined that the selected additional information is the predetermined information.

18. The computer program product as set forth in claim 17, wherein said processing for assuring the secrecy of said image data is a processing for receiving authentication information for instructing the printer to start executing the printing based on the generated job.

19. The computer program product as set forth in claim 17, wherein said processing for assuring the secrecy of said image data is a processing for encrypting the image data.

20. The computer program product as set forth in claim 17, wherein said computer readable program code means further comprising instructions for:
generating additional image data in accordance with the selected additional information;
synthesizing the image data generated in accordance with the selected additional information with the image data to be printed; and
generating a job for instructing the printing based on the synthesized image data.

21. The computer program product as set forth in claim 20, wherein said processing for assuring the secrecy of said image data is a processing for receiving authentication information for instructing the printer to start executing the printing based on the generated job.

22. The computer program product as set forth in claim 20, wherein said processing for assuring the secrecy of said image data is a processing for encrypting the image data.
